(19) United States
(12) Patent Application Publication
(10) Pub. No.: US 2007/0268867 A1
(43) Pub. Date: Nov. 22, 2007

(54) Access Point Polling Systems and Methods

(75) Inventor: Menzo Wentink, Utrecht (NL)

Correspondence Address: THOMAS, KAYDEN, HORSTEMEYER & RISLEY, L.L.P., 100 GALLERIA PARKWAY, SUITE 1750, ATLANTA, GA, 30339-5948, US

(73) Assignee: CONEXANT SYSTEMS, INC, Newport Beach, CA (US)

(21) Appl. No.: 11/750,684

(22) Filed: May 18, 2007

Related U.S. Application Data
(60) Provisional application No. 60/801,300, filed on May 18, 2006.

(51) Int. Cl. H04Q 7/00

(52) U.S. Cl. 370/331

(57) ABSTRACT

Embodiments of AP polling systems and methods are disclosed. One method embodiment, among others, comprises soliciting by a station a response from an access point (AP), and determining whether data for the station is stored at the AP based on the response.

### CROSS-REFERENCE TO RELATED APPLICATION

This application claims priority to copending U.S. provisional application having Ser. No. 60/801,300, filed on May 18, 2006, which is incorporated herein by reference in its entirety.

### BACKGROUND

1. Field of the Invention

The present disclosure is generally related to communication systems, and, more particularly, is related to wireless communication systems and methods.

2. Related Art

Wireless communication systems are widely deployed to provide various types of communication, such as voice, data, and so on. Much has changed in the way of wireless devices from the early days of bulky walkie-talkies and base-mounted car phones. Miniaturization of components and advancements in protocols and methods over the years have resulted in cell phones that can rest on an ear lobe, multi-media entertainment devices like the IPOD that provide hours of entertainment while fitting comfortably in the palm of one's hand, or digital cameras that can store and transmit literally hundreds of pictures.

Consumers desire low-profile devices, but not at the expense of performance.

For instance, consider cell phones. Consumers generally prefer to have long-lasting operation in terms of battery power while retaining the ability to pick up their phone at any time or location and enjoy optimal reception. However, these performance features are often subject to competing interests. That is, current technology implements roaming to determine the proximity to various stations (e.g., peer stations or access points). Roaming may be performed during periods that a consumer is engaged in a call, or during standby (e.g., when the consumer is not engaged in a call), and typically is implemented using active scanning or passive scanning.

For instance, in standby in a wireless, local area network (WLAN) having a basic service set (BSS) configuration, a cell phone (or other device) periodically wakes-up at a time corresponding to when a beacon is expected to be transmitted by an associated access point (AP). As is known, within the beacon is a field referred to in 802.11 parlance as a traffic indication map or TIM. The TIM comprises an association number corresponding to, for instance, the cell phone. If the TIM bit is set (e.g., set to 1), that setting provides an indication to the cell phone that the AP is storing traffic or data for the cell phone and hence the cell phone is ready to receive a call. If the TIM bit is not set (e.g., set to 0), then the cell phone can return to standby since the non-setting is an indication that no traffic for the cell phone is buffered in the AP. Hence, the beacon serves to indicate whether traffic is buffered at the AP for the associated station (e.g., cell phone).

The length or period of time that a cell phone may wait upon commencing the wake mode varies depending on, among other factors, the length of the beacon. In some implementations, the length of the beacon may be 1½ milliseconds (msecs). Beacons tend to be longer because they are used to convey an ever increasing amount of information. Also, beacons are typically transmitted at the lowest PHY rate, which implies that the time it takes to receive a beacon may become quite substantial. Further, when the time between beacon receptions increases, the additional time to be included to account for timing skews may increase as well. Adding to the wake time is the fact that the cell phone wakes-up prior to the expected time of beacon transmission (also referred to as the target beacon transmission time or TBTT). Further wake time may occur due to waking up too early, or interruption of the TBTT due to transmission by another. Such delays tend to place a drain on the battery and hence encroach on the amount of standby time.

### SUMMARY

Embodiments of access point (AP) polling systems and methods are disclosed.

One method embodiment, among others, comprises soliciting by a station a response from an access point (AP), and determining whether data for the station is stored at the AP based on the response.

One system embodiment, among others, comprises a station configured to solicit a response from an AP and determine whether data for the station is stored at the AP based on the response.

Another system embodiment, among others, comprises means for soliciting by a station a response from an AP, means for receiving a response, and means for determining whether data for the station is stored at the AP based on the response.

Other systems, methods, features, and advantages of the present disclosure will be or become apparent to one with skill in the art upon examination of the following drawings and detailed description. It is intended that all such additional systems, methods, features, and advantages be included within this description, and be within the scope of the present disclosure.

### BRIEF DESCRIPTION OF THE DRAWINGS

Many aspects of the disclosed systems and methods can be better understood with reference to the following drawings. The components in the drawings are not necessarily to scale, emphasis instead being placed upon clearly illustrating the principles of the disclosed systems and methods. Moreover, in the drawings, like reference numerals designate corresponding parts throughout the several views.

FIG. 1 is a block diagram of an exemplary communication environment in which embodiments of access point (AP) polling systems and methods can be implemented.

FIG. 2 is a block diagram that illustrates an embodiment of an AP polling system embodied in one of the devices shown in FIG. 1.

FIGS. 3-6B are flow diagrams that illustrate several embodiments of AP polling methods executed by the AP polling system shown in FIG. 2.

### DETAILED DESCRIPTION

Disclosed herein are various embodiments of access point (AP) polling systems and methods, herein collectively referred to also as AP polling systems, which provide an alternative technique to determining the buffered data status. That is, the AP polling systems described herein ignore the beacon, and instead, actively solicit the buffered data status from the AP. Through this solicitation, the battery life can be preserved and the standby time reduced for at least the reason that the wake time is reduced when compared to conventional techniques. Additionally, the solicited response may also be used to gauge the remaining signal strength with the AP.

Such AP polling systems are described below in the context of 802.11 compliant, communication systems, though the principles described herein can be extended to other communication systems and protocols and hence are not so limited. Additionally, the AP polling system embodiments are described in the context of standby operation, but it should be appreciated by one having ordinary skill in the art in the context of the present disclosure that the principles and methods described herein can also be extended to non-standby operation, and hence considered within the scope of the disclosure.

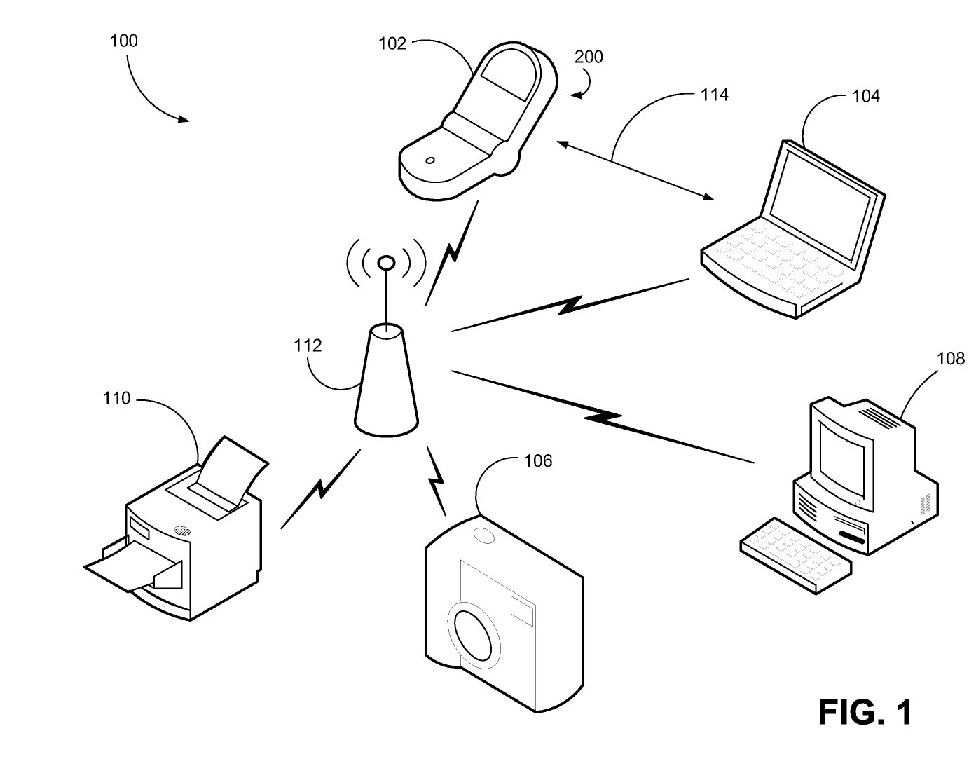

FIG. 1 is a block diagram of an exemplary communication environment 100 in which embodiments of AP polling systems and methods can be implemented. The environment 100 comprises a plurality of wireless and wired devices, one or more of which may be configured to operate as a wireless and wired device. One or more of the devices shown in FIG. 1 may incorporate AP polling systems and methods, as described further below. Exemplary wireless devices include a cell phone 102, a laptop computer 104 (which, along with other devices, may communicate with the cell phone 102 in a direct link mechanism as represented by direct link 114, such as disclosed in 802.11e), and a digital camera 106. The wired devices (e.g., with wireless capability) include a personal computer (PC) 108 and a printer 110. In the exemplary environment 100 shown in FIG. 1, the cell phone 102 is in communication (e.g., radio frequency communication) with the laptop 104 and the PC 108 via an access point (AP) 112, and the digital camera 106 is in communication with the printer 110 and the PC 108 via the AP 112. For instance, such communications may be used to load pictures from the digital camera 106 to the PC 108. For illustrative purposes, the cell phone 102 is shown as an appliance that embodies an embodiment of the AP polling system 200, though not limited to this arrangement.

Note that communication between the various devices may employ one or more of a plurality of protocols, including 802.11 (e.g., 802.11a, 802.11b, 802.11e, 802.11g, 802.11n), WiMax, Ultra-Wide Band (UWB), Bluetooth, among other technologies. Additionally, although the communication environment 100 is shown as a basic service set (BSS) configuration, in some embodiments, communication among one or more devices may be implemented using peer-to-peer (also known as adhoc in many wireless technologies) communication in lieu of or in addition to communication through the AP 112.

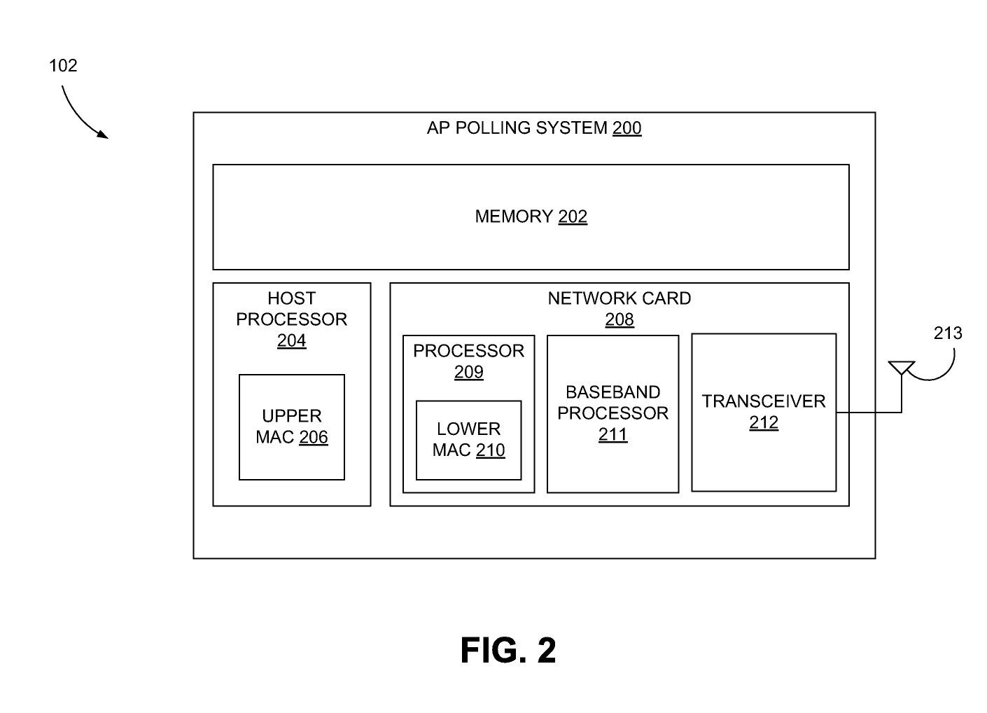

FIG. 2 is a block diagram that illustrates an embodiment of an AP polling system 200 executed in the cell phone 102 shown in FIG. 1, with the understanding that other devices may embody the AP polling system 200 in addition to, or in lieu of, the cell phone 102. Note that the devices shown in FIGS. 1 and 2 are exemplary in nature, and that the AP polling system 200 may be implemented in one of a plurality of different devices or appliances, including computers (desktop, portable, laptop, etc.), consumer electronic devices (e.g., multi-media players, music players), compatible telecommunication devices, personal digital assistants (PDAs), or any other type of network devices, such as printers, fax machines, scanners, hubs, switches, routers, set-top boxes, televisions with communication capability, etc.

The AP polling system 200 can be implemented using digital circuitry, analog circuitry, or a combination of both, and is embodied in one embodiment using a combination of hardware and software. As to hardware, one or more components of the AP polling system 200 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In one embodiment, the AP polling system 200 comprises a memory 202, a host processor (or media access controller in some embodiments) 204 executing code (e.g., a driver) referred to also as an upper MAC 206, and a network card 208 (e.g., network interface card or wireless card) coupled to the host processor 204, the network card 208 comprising a processor or media access controller 209 executing code referred to as a lower MAC 210, a baseband processor 211 coupled to the processor 209, a transceiver 212 coupled to the baseband processor 211, and an antenna 213 coupled to the transceiver 212. Note that the above-described components of the AP polling system 200 are also collectively referred to as a station. In some embodiments, a station may comprise additional or different components. Further, in some embodiments, the lower MAC 210 can be incorporated into the baseband processor 211. The transceiver 212 comprises in one embodiment such well-known transceiver components including filters, amplifiers (e.g., power amplifiers, switches, etc.). The host processor 204 and processor (or media access controller) 209 may each be embodied as a digital signal processor (DSP), a microprocessor (MCU), a general purpose processor, or an application specific integrated circuit (ASIC), among others devices. One having ordinary skill in the art should appreciate that additional components not shown can be used (e.g., a host processor interface, various busses, etc.), yet which are omitted for brevity.

In one embodiment, preparation, transmission, and reception of frames, as well as the determination of signal strength and whether data is stored in the AP based on the solicited response, is under the control of the lower MAC 210 as executed by the processor 209. In some embodiments, control of the aforementioned functionality is solely by either the upper MAC 206 or the lower MAC 210, and in some embodiments, the execution of the MACs 206 and 210 may be implemented via a single processor or on more than two processors. In some embodiments, functionality of the upper and lower MACs 206 and 210 may be collectively performed in a single MAC.

In one embodiment, the upper MAC 206 and lower MAC 210 each comprise software (e.g., firmware) residing on the respective processors 204 and 209, respectively, and that is executed by a suitable instruction execution system. In some embodiments, functionality of the upper MAC 206 and lower MAC 210 may comprise software stored in memory (e.g., memory 202) or other computer readable medium (e.g., optical, magnetic, semiconductor, etc.), and executed by the host processor 204 or other processor.

Having described one embodiment of the AP polling system 200, one method employed by the AP polling system 200 is that of using a periodic power save (PS) poll.

That is, the AP polling system 200 periodically transmits a PS-poll to check if there is any traffic buffered at the AP 112. The AP 112 is configured to transmit a data frame (e.g., null frame) with the more data bit not set in case no traffic is buffered. The AP 112 can be expected to send a response (e.g., in addition to an acknowledgement or ACK frame) comprising the data (if buffered) or a null frame with or with the more data bit not set. In some embodiments, preceding the data may be a null frame with the more data bit set. The response to the PS-poll may be used to gauge the remaining signal strength with the AP, as input to a possible roaming decision for instance.

Another method employed by the AP polling system 200 involves toggling between a constantly awake mode (CAM) and a power save mode (PSM). The AP polling system 200 polls the AP by periodically toggling between the CAM and PSM mode. Toggling is performed in one embodiment by transmitting a data frame (e.g., null frame) with a power management (PM) bit not set (e.g., equal to 0), followed after a timeout by a data frame (e.g., null frame) with the PM bit set (e.g., equal to 1). The CAM period may, for instance, last 1-3 milliseconds (msecs), which provides the AP polling system 200 with a reasonable certainty about whether any traffic is buffered at the AP or not.

An additional method employed by the AP polling system 200 involves unscheduled asynchronous power save delivery (U-ADSP) capable APs. For U-ADSP capable APs, a service period is commenced periodically, which is finished by the AP using the end of service period (EOSP) bit when no traffic is buffered.

Note that the various frame fields referenced above, including the more data bit, EOSP, etc. are known to those having ordinary skill in the art, and can be referenced from the public document entitled IEEE publication P802.11-REVmaD9.0, which is entitled “Draft Standard For Information Technology—Telecommunications and information exchange between systems—Local and metropolitan area networks—Specific Requirements Part 11: Wireless LAN Medium Access Control (MAC) and Physical Layer (PHY) specifications.”

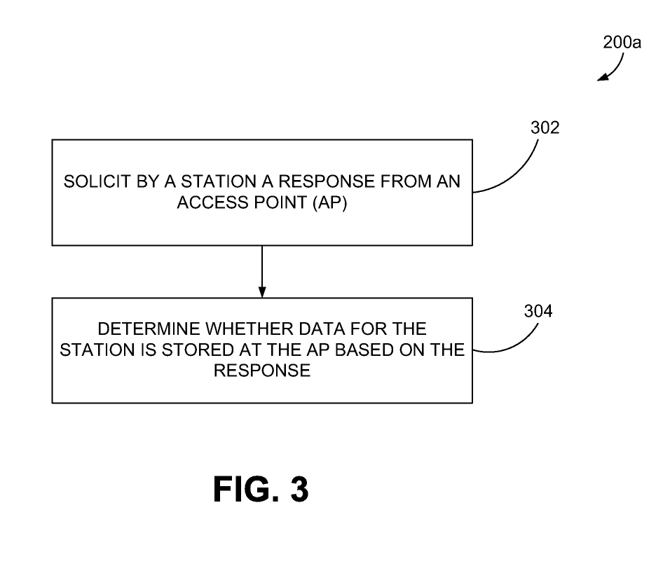

In view of the description above, it can be appreciated that one general AP polling method embodiment, denoted as method 200a and shown in FIG. 3, comprises, soliciting by a station a response from an access point (AP) (302), and determining whether data for the station is stored at the AP based on the response (304). Note that in some embodiments, the response may be a lack of response from the AP (e.g., no frame sent by the AP).

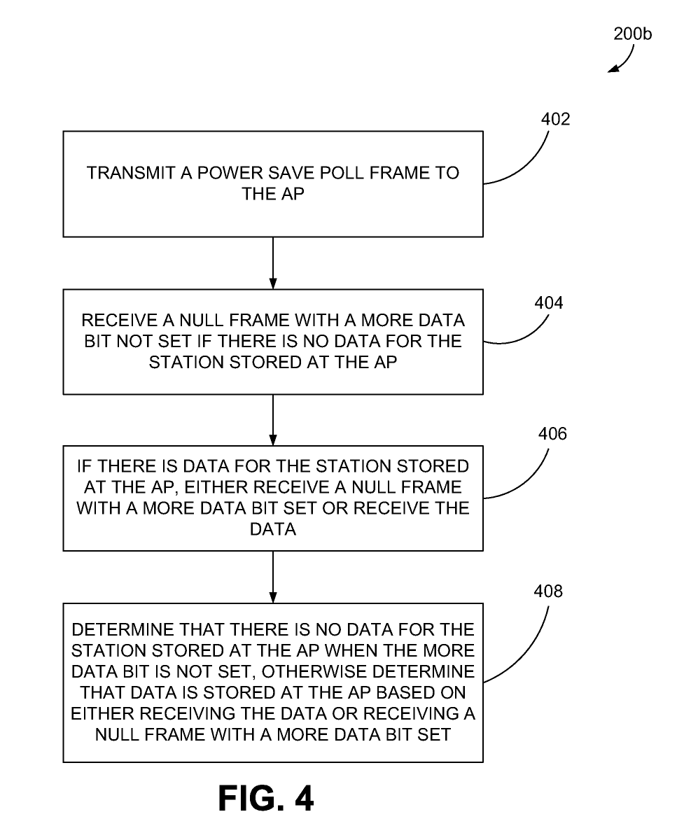

Another method embodiment pertaining to the PS-poll method described above, denoted as method 200b and shown in FIG. 4, comprises transmitting a power save poll frame to the AP (402), receiving a null frame with a more data bit not set if there is no data for the station stored at the AP (404), if there is data for the station stored at the AP, either receiving a null frame with a more data bit set or receiving the data (406), and determining that there is no data for the station stored at the AP when the more data bit is not set, otherwise, determining that data is stored at the AP based on either receiving the data or receiving a null frame with a more data bit set (408).

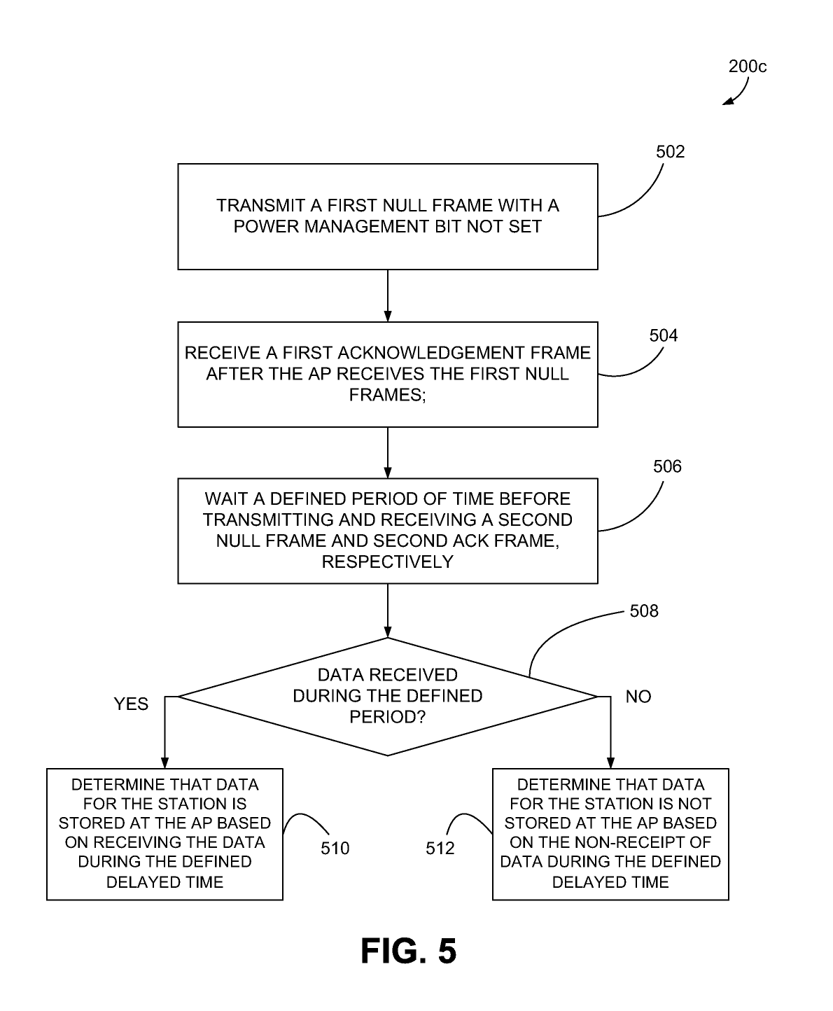

Another method embodiment pertaining to the toggling method described above, denoted as method 200c and shown in FIG. 5, comprises transmitting a first null frame with a power management bit not set (502), receiving a first acknowledgement (ACK) frame after the AP receives the first null frames (504), waiting a defined period of time before transmitting and receiving a second null frame and second ACK frame, respectively (506), determining if data is received during the defined period of time (508), and if so, determining that data for the station is stored at the AP based on receiving the data during the defined period of time (510), and if not, determining that data for the station is not stored at the AP based on the non-receipt of data during the defined period of time (512).

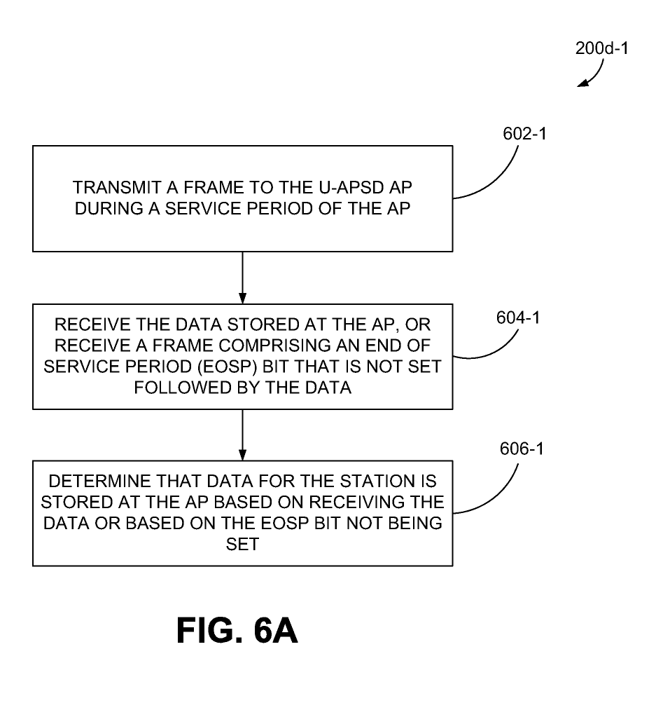

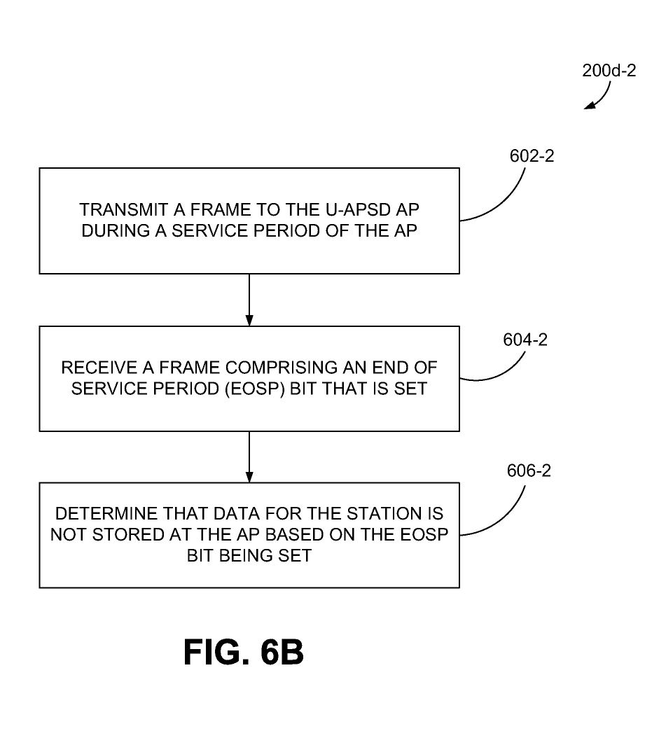

Another method embodiment pertaining to the U-ASPD capable AP method described above, denoted as method 200d-1 and shown in FIG. 6A, comprises transmitting a frame to the U-APSD AP during a service period of the AP (602-1), receiving the data stored at the AP, or receiving a frame comprising an end of service period (EOSP) bit that is not set followed by the data (604-1), and determining that data for the station is stored at the AP based on receiving the data or based on the EOSP bit not being set (606-1).

Another method embodiment pertaining to the U-ASPD capable AP method described above, denoted as method 200d-2 and shown in FIG. 6B, comprises transmitting a frame to the U-APSD AP during a service period of the AP (602-2), receiving a frame comprising an end of service period (EOSP) bit that is set (604-2), and determining that data for the station is not stored at the AP based on the EOSP bit being set (606-2).

Any process descriptions or blocks in flow diagrams shown in FIGS. 3-6B should be understood as representing modules, segments, or portions of code which include one or more executable instructions for implementing specific logical functions or steps in the process, and alternate implementations are included within the scope of the embodiments described herein in which functions may be executed out of order from that shown or discussed, including substantially concurrently or in reverse order, depending on the functionality involved, as would be understood by those reasonably skilled in the art. Additionally, the methods illustrated in the flow diagrams of FIGS. 3-6B are not limited to the system embodiments shown in FIGS. 1 and 2, but may be extended to other architectures and systems as should be appreciated by one having ordinary skill in the art in the context of this disclosure.

It should be emphasized that the above-described embodiments are merely possible examples of implementations, merely set forth for a clear understanding of the principles of the disclosure. Many variations and modifications may be made to the above-described embodiment(s) without departing substantially from the scope of the disclosure. All such modifications and variations are intended to be included herein within the scope of this disclosure.

At least the following is claimed:

1. A method, comprising:
soliciting by a station a response from an access point (AP); and
determining whether data for the station is stored at the AP based on the response.

2. The method of claim 1, wherein soliciting comprises transmitting a power save poll frame to the AP.

3. The method of claim 2, wherein determining further comprises receiving a null frame with a more data bit not set if there is no data for the station stored at the AP, or if there is data for the station stored at the AP, either receiving a null frame with a more data bit set or receiving the data.

4. The method of claim 3, wherein determining further comprises determining that there is no data for the station stored at the AP when the more data bit is not set, otherwise determining that data is stored at the AP based on either receiving the data or receiving a null frame with a more data bit set.

5. The method of claim 1, further comprising determining a quality of the link between the station and the AP based on the response.

6. The method of claim 1, wherein the soliciting is responsive to terminating a standby-mode.

7. The method of claim 6, further comprising returning to the standby mode subsequent to a defined period of time after receiving the response.

8. The method of claim 1, wherein soliciting comprises:
transmitting a first null frame with a power management bit not set;
waiting a defined time period; and
transmitting a second null frame with the power management bit set.

9. The method of claim 8, wherein determining further comprises receiving first and second acknowledgement frames after the AP receives the first and second null frames, respectively.

10. The method of claim 9, wherein determining further comprises receiving data during the defined time period.

11. The method of claim 10, wherein determining comprises determining that data for the station is stored at the AP based on receiving the data during the defined time period.

12. The method of claim 9, wherein determining comprises determining that data for the station is not stored at the AP based on the non-receipt of data during the defined time period.

13. The method of claim 1, wherein the AP comprises an unscheduled asynchronous power save delivery (U-APSD) capable AP.

14. The method of claim 13, wherein soliciting comprises transmitting a frame to the U-APSD AP during a service period of the AP.

15. The method of claim 14, wherein determining further comprises receiving the data stored at the AP, or receiving a frame comprising an end of service period (EOSP) bit not set followed by the data.

16. The method of claim 15, wherein determining comprises determining that data for the station is stored at the AP based on receiving the data or based on receiving the frame with the EOSP bit not set.

17. The method of claim 14, wherein determining further comprises receiving a frame comprising an EOSP bit that is set.

18. The method of claim 17, wherein determining comprises determining that data for the station is not stored at the AP based on the frame with the EOSP bit not set.

19. The method of claim 1, further comprising ignoring a beacon sent by the AP.

20. The method of claim 1, wherein the soliciting and determining are implemented in an appliance.

21. A system, comprising:
a station configured to solicit a response from an access point (AP) and determine whether data for the station is stored at the AP based on the response.

22. The system of claim 21, wherein the station further comprises a processor executing media access control software to determine a quality of the link between the station and the AP based on the response.

23. The system of claim 21, wherein the station further comprises a processor executing media access control software in cooperation with a transceiver to solicit responsive to terminating a standby-mode.

24. The system of claim 23, wherein the station further comprises a processor executing media access control software in cooperation with a transceiver to return to the standby mode subsequent to a defined period of time after receiving the response.

25. The system of claim 21, wherein the station further comprises a processor executing media access control software in cooperation with a transceiver to:
transmit a power save poll frame to the AP;
receive a null frame with a more data bit not set if there is no data for the station stored at the AP, or
if there is data for the station stored at the AP, either receive a null frame with a more data bit set or receive the data; and
determine that there is no data for the station stored at the AP when the more data bit is not set, otherwise
determine that data is stored at the AP based on either receiving the data or receiving a null frame with a more data bit set.

26. The system of claim 21, wherein the station further comprises a processor executing media access control software in cooperation with a transceiver to:
transmit a first null frame with a power management bit not set;
receive a first acknowledgement frame after the AP receives the first null frames;
wait a defined period of time;
transmit a second null frame with the power management bit set.
receive a second acknowledgement frame after the AP receives the second null frame.

27. The system of claim 26, wherein the station further comprises a processor executing media access control software in cooperation with a transceiver to receive data during the defined period of time.

28. The system of claim 27, wherein the station further comprises a processor executing media access control software in cooperation with a transceiver to determine that data for the station is stored at the AP based on receiving the data during the defined period of time.

29. The system of claim 26, wherein the station further comprises a processor executing media access control software in cooperation with a transceiver to determine that data for the station is not stored at the AP based on the non-receipt of data during the defined period of time.

30. The system of claim 21, wherein the AP is configured for unscheduled asynchronous power save delivery (U-APSD) operation.

31. The system of claim 30, wherein the station further comprises a processor executing media access control software in cooperation with a transceiver to:
transmit a frame to the U-APSD AP during a service period of the AP;
receive the data stored at the AP, or receive a frame comprising an end of service period (EOSP) bit that is not set followed by the data; and
determine that data for the station is stored at the AP based on receiving the data or based on the EOSP bit not being set.

32. The system of claim 30, wherein the station further comprises a processor executing media access control software in cooperation with a transceiver to:
transmit a frame to the U-APSD AP during a service period of the AP;
receive a frame comprising an end of service period (EOSP) bit that is set; and
determine that data for the station is not stored at the AP based on the EOSP bit being set.

33. The system of claim 21, wherein the station further comprises a processor executing media access control software in cooperation with a transceiver to ignoring a beacon transmitted by the AP.

34. The system of claim 21, wherein the station is embodied in an appliance.

35. A system, comprising:
means for soliciting by a station a response from an access point (AP);
means for receiving a response; and
means for determining whether data for the station is stored at the AP based on the response.
